(19) United States
(12) Patent Application Publication
(10) Pub. No.: US 2006/0017985 A1
(43) Pub. Date: Jan. 26, 2006

(54) Method of compressing/decompressing image and apparatus using the same

(75) Inventor: Jae-hyun Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/150,219

(22) Filed: Jun. 13, 2005

(30) Foreign Application Priority Data
Jul. 21, 2004 (KR) 10-2004-0057004

(51) Int. Cl. G06F 15/00

(52) U.S. Cl. 358/426.07

(57) ABSTRACT

Provided are a method of compressing and decompressing an image signal and an apparatus using the same that divides image domains based on the contents of image and hierarchically compresses and decompresses the divided image domain by using a bit rate and/or a layer rate that are different from each other. The method includes operations of: classifying a received bit stream into multiple layers; decoding bit streams classified by each layer, and obtaining decompressed image signals of each layer; and composing the decompressed image signals of each layer. Accordingly, it is possible to transmit or store the important image information in an environment where transmission is poor or storage capacity is insufficient.

### BACKGROUND OF THE INVENTION

This application claims the priority of Korean Patent Application No. 10-2004-0057004, filed on Jul. 21, 2004, in the Korean Intellectual Property Office, the disclosure of which is incorporated herein in its entirety by reference.

1. Field of the Invention

The present invention relates to a method of compressing/decompressing an image and an apparatus using the same, and more particularly, to a method of hierarchically compressing and decompressing an image signal and an apparatus using the same.

2. Description of the Related Art

A conventional technology of compressing and decompressing an image in order to record and transmit an image of high definition requires a massive storage space and a large transmission bandwidth. However, as apparatus for transmitting and recording an image at a low bit rate, such as a motion picture phone or a mobile storage device have been recently proposed, there is required a technology of compressing and decompressing an image that can efficiently utilize storage space and bandwidth while maintaining the ability to deliver information with a predetermined level of quality. Accordingly, a variety of technologies of hierarchically compressing and decompressing an image are proposed.

### SUMMARY OF THE INVENTION

The present invention provides a method of compressing and decompressing an image signal and an apparatus using the same that divides an image domain based on the contents of an image and hierarchically compresses and decompresses the divided image domains by using different bit rates and/or layer rates.

The present invention also provides a method of compressing and decompressing an image signal and an apparatus using the same that divides an image domain based on significance of contents and hierarchically compresses and decompresses the divided image domains by using a layer rate and/or a bit rate depending on the significance of contents, transmission/recording environments, and purpose of application.

According to an aspect of the present invention, there is provided a method of decompressing an image, the method comprises the operations of: classifying a received bit stream into multiple layers; decoding the bit stream classified by each layer, and obtaining a decompressed image signal of each layer; and composing the decompressed image signal of each layer.

A bit stream classified by each layer may be decoded at a decompression rate corresponding to a compression rate based on target layer rates which are different from each other by each layer, and classifying the layer based on layer information included in the received bit stream. The image layer information may comprise a layer pattern capable of dividing the image domain by contents. The target layer rates which are different from each other may be determined according to significance of contents of the image.

The bit stream classified by each layer may be decoded at the decompression rate corresponding to the compression rate based on a target bit rate used in a decoding and the target layer rates which are different from each other by each layer.

The bit stream classified by each layer may be decoded at the decompression rate corresponding to the compression rate based on the target bit rate used in an encoding.

According to another aspect of the present invention, there is provided a method of decompressing an image, the method comprises the operations of: classifying a received bit stream into multiple layers based on image layer information; obtaining a decompressed image signal by decoding a bit stream of a layer having the highest significance in the multiple layers; obtaining an image signal corresponding to other layers than the layer having the highest significance in the multiple layers from a previously decompressed image signal based on additional information included in the received bit stream; and composing the decompressed image signal and the image signal obtained from the previously decompressed image signal, and outputting the composed image signal to the decompressed image signal.

The layer having the highest significance may include at least one domain between a boundary domain of the image having the highest significance in the images and a middle domain of the image.

According to yet another aspect of the present invention, there is provided an apparatus for decompressing an image, the apparatus comprising: an inverse streamer configured to, if a bit stream is received, analyze the bit stream to be classified into multiple layers and transmit the bit stream by layers; a decoding portion configured to decode the bit stream by each layer transmitted from the inverse streamer and output the decompressed image signal of each layer; and an image composing portion configured to compose the decompressed image signal of each layer.

The inverse streamer may classify the received bit stream into the multiple layers based on layer information included in the received bit stream.

According to still another aspect of the present invention, there is provided an apparatus for decompressing an image, the apparatus comprising: an inverse streamer configured to classify a received bit stream into multiple layers and output readout information based on a bit stream of a layer having the highest significance and additional information of other layers than the layer having the highest significance in the multiple layers; a decoding portion configured to decode the bit stream transmitted from the inverse streamer and output the decompressed image signal; an image composing portion configured to compose the decompressed image signal of each layer; a frame memory configured to provide a previously decompressed image signal of image domain corresponding to the other layers based on the readout information; and an image composing portion configured to compose the decompressed image signal outputted from the decoding portion and the previously decompressed image signal provided from the frame memory and output the composed image signal.

The layer having the highest significance may include at least one domain between a boundary domain of the image having the highest significance in the images and a middle domain of the image.

According to a further aspect of the present invention, there is provided a method of compressing an image, the method comprises the operations of: extracting image feature information; generating a layer pattern of the image based on the extracted image feature information and a number of encoding layers of the image; segmenting the image domain based on the layer pattern; encoding an image signal by the segmented image domain; and composing the encoded image signal by image domains and outputting the composed image signal.

The encoding operation may encode an image signal of the segmented image domain of a compression rate based on target layer rates which are different from each other by the segmented image domain according to the significance of contents of the segmented image domain.

The encoding operation may encode an image signal of the segmented image domain at a compression rate determined based on a target bit rate and target layer rates which are different from each other by the segmented image domain.

The encoding operation may encode an image signal of the segmented image domain at a compression rate determined based on a target bit rate.

According to a further aspect of the present invention, there is provided a method of compressing an image, the method comprises the operations of: extracting image feature information; generating a layer pattern of the image based on the extracted image feature information and a number of encoding layers of the image; segmenting the image domain based on the layer pattern; and encoding an image signal of the image domain having the highest significance of the image in the segmented image domain.

The method may further comprise the operation of composing additional information necessary for decompressing image domains other than the image domain having the highest significance in the image among the segmented image domain and the encoded image signal.

According to a further aspect of the present invention, there is provided an apparatus for compressing an image, the apparatus comprising: an image feature extracting portion configured to extract feature information of an input image, and generate a layer pattern corresponding to the image based on the extracted image feature information and a number of encoding layers of the image; a domain segmenting portion configured to segment the image domain based on the layer pattern; and an encoding portion configured to encode an image signal of the image domain segmented by the domain segmenting portion.

According to a further aspect of the present invention, there is provided an apparatus for compressing an image, the apparatus comprising: an image feature information extracting portion configured to extract feature information of an input image, and generate a layer pattern corresponding to the image based on the extracted image feature information and a number of encoding layers of the image; a domain segmenting portion configured to segment the image domain based on the layer pattern; and an encoding portion configured to encode an image signal of image domain having the highest significance in the image domain segmented by the domain segmenting portion, and output the encoded image signal and additional information necessary for decompressing image signals of other image domains which are not encoded in the segmented image domain as a bit stream.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an apparatus for compressing an image according to an embodiment of the present invention;

FIG. 2B is an example of a layer pattern corresponding to FIG. 2A;

FIG. 3 is a block diagram illustrating an encoding portion of FIG. 1;

FIG. 4 is a block diagram illustrating a layer encoder of FIG. 3;

FIG. 5 is a block diagram illustrating a streamer of FIG. 3;

FIG. 6 is a block diagram illustrating an apparatus for decompressing an image according to an embodiment of the present invention;

FIG. 7 is a block diagram illustrating an inverse streamer of FIG. 6;

FIG. 8 is a flow chart describing the operation of a method for compressing an image according to an embodiment of the present invention;

FIG. 9 is a flow chart describing the operation of a method for decompressing an image according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

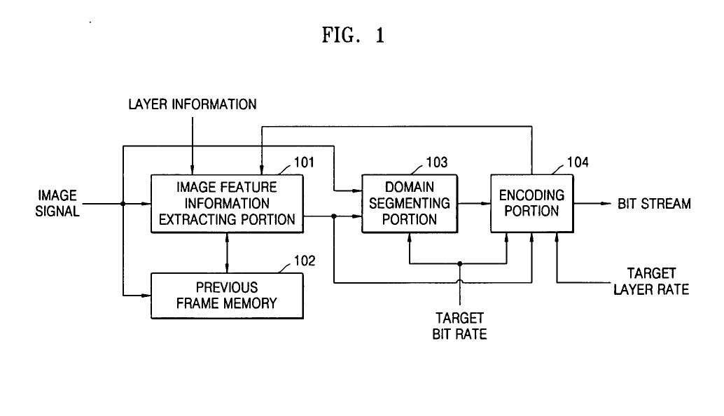

FIG. 1 is a block diagram illustrating an apparatus for compressing an image according to an embodiment of the present invention. Referring to FIG. 1, an apparatus for compressing an image includes an image feature information extracting portion 101, a previous frame memory 102, a domain segmenting portion 103, and an encoding portion 104.

The image feature information extracting portion 101 extracts image feature information that can divide image domains into an image domain whose significance is high and an image domain whose significance is not high based on the contents of an input image. The image domain whose significance is high should include contents that are sure to be recorded or transmitted in the input mage.

For example, an image domain whose significance is high may be an object domain. The image domain whose significance is not high includes contents that might not be recorded or transmitted in the input image. If an image domain whose significance is high is an object domain, the image domain whose significance is not high may be a background domain. The image domain whose significance is high may be defined as an image domain having the highest significance for other image domains of the input image. That is why the input image can be divided into two or more image domains.

The image feature information extracting portion 101 can extract image feature information considering complexity or activity, etc. of the input image. In case of extracting image feature information considering the activity, first, the image feature information extracting portion 101 segments the input image into segments of a predetermined unit. Then, the image feature information extracting unit 101 calculates pixel data of a present frame and pixel data of a previous frame that are stored in the previous frame memory 102 every segment, as shown in Equation 1, to obtain activity (SEG-ACT) in a spatial domain.

$$SEG - ACT ( i , j ) = {\sum }_{x = 0}^{x = z} {\sum }_{y = 0}^{y = z} \vert {P}_{t} ( x , y ) - {P}_{t - 1} ( x , y ) \vert , \qquad [ Equation 1 ]$$

In Equation 1, Pt(x, y) is pixel data of the present frame, and Pt-1l(x, y) is pixel data at the location corresponding to the Pt(x, y) of the previous frame.

In a case where there is almost no motion of the present frame with respect to the previous frame, the activity obtained in a spatial domain every segment is close to 0. Therefore, if the activity obtained in a spatial domain by unit of segment is close to 0, the image feature information extracting portion 101 extracts activity of a frequency domain that is obtained by units of a segment in the previous frame as image feature information in units of a segment. The activity of the frequency domain is obtained by using a Discrete Cosine Transform (DCT) coefficient. The activity of the frequency domain is provided from the encoding portion 104.

In a case where there is motion of the present frame with respect to the previous frame, the image feature information extracting portion 101 extracts activity of a spatial domain that is obtained by units of a segment for the present frame as image feature information of the present frame in units of a segment. If the activity of a spatial domain obtained by units of a segment for the present frame is not close to 0, it is determined that there is motion of the present frame relating to the previous frame.

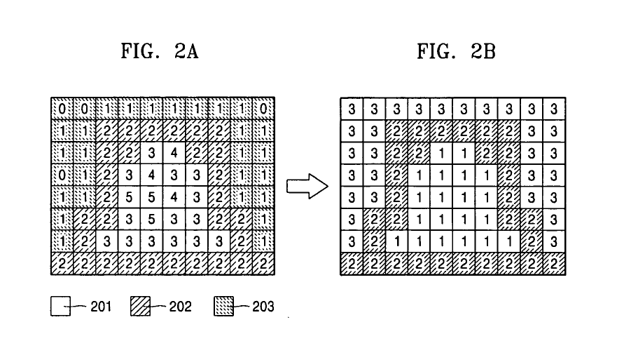

As described above, if the image feature information is extracted in units of a segment, the image feature information for the input image signal can be obtained in units of a segment as shown in FIG. 2A. FIG. 2A illustrates an image domain whose significance is low in an input image signal, as the image feature information in unit of segment becomes close to 0, and an image domain whose significance is high in an input image signal, as the image feature information in unit of segment does not become close to 0.

Meanwhile, in order to achieve efficient domain segmenting, a domain near the domain whose significance is high (e.g., a boundary domain) or a middle domain whose image feature information is near 0 may be regarded as a domain whose significance is low. However, since such domains have a substantially high significance, the domains can be classified into a domain having high significance.

Referring to FIG. 2A, the corresponding contents have the highest significance in a 201 image domain, the corresponding contents have the lowest significance in a 203 image domain, and the contents of a 202 image domain have a significance lower than that of the 201 image domain and higher than that of the 203 image domain. Since the 202 image domain is a boundary domain between the 201 image domain and the 203 image domain, the 201 image domain and the 202 image domain can be classified into a domain having high significance.

If the image feature information is extracted in units of a segment, the image feature information extracting portion 101 normalizes the image feature information extracted in units of a segment based on layer information relating to an encoding layer which is constituted in the encoding portion 104 and generates a layer pattern corresponding to an input image signal.

If the encoding layer of the encoding portion 104 is constituted as three layers, the image feature information extracting portion 101 normalizes the extracted image feature information to 3 as shown in FIG. 2A and generates the layer pattern having the image feature information in units of a segment as shown in FIG. 2B. FIG. 2B is an example of normalizing 0 and 1 to a layer 3, 2 to a layer 2, and 3, 4, and 5 to a layer 1 regarding the image feature information as obtained in FIG. 2A.

The layer patterns are each transmitted to the domain segmenting portion 103 and the encoding portion 104.

The previous frame memory 102 stores a previous frame image signal. If the layer pattern of the present frame is generated from the image feature information extracting portion 101, the previous frame image signal stored in the previous frame memory 102 is updated to a present frame image signal.

If the layer pattern is inputted as shown in FIG. 2B, the domain segmenting portion 103 segments an image domain of the present frame based on layer information allotted by units of a segment and transmits the segmented results to the encoding portion 104.

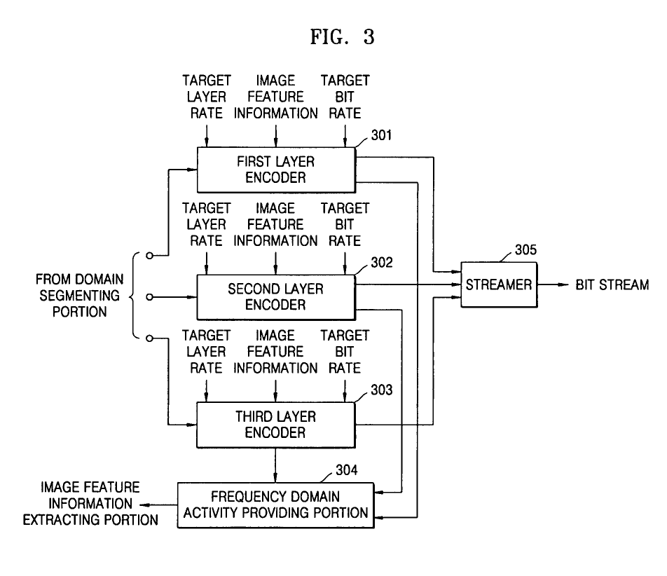

If the encoding portion 104 includes first through third layer encoders 301, 302, and 303 as shown in FIG. 3, the domain segmenting portion 103 transmits an image signal of the image domain of the present frame corresponding to a segment at which layer information 1 of FIG. 2B is allotted to the first layer encoder 301. The domain segmenting portion 103 transmits an image signal of the image domain of the present frame corresponding to a segment at which layer information 2 of FIG. 2B is allotted to the second layer encoder 302. The domain segmenting portion 103 transmits an image signal of the image domain of the present frame corresponding to a segment at which layer information 3 of FIG. 2B is allotted to the third layer encoder 303. To this effect, the domain segmenting portion 103 may include a switch for selectively transmitting image signals to the first through third layer encoders 301, 302, and 303 by units of a segment.

The domain segmenting portion 103 does not transmit the image signal of the segment which is included in the image domain having low significance to the encoding portion 104 according to an established target bit rate, or can transmit it to be compressed at a layer rate lower than that of the domain having high significance, even if transmitted. Further, the domain segmenting portion 103 can divide the segmented image domains by layers to be transmitted to the encoding portion 104 so that the segmented image domains by layers can be compressed at the target layer rates which are different from each other by each layer.

For example, in a system that records or transmits encoding information at a bit rate having a low target bit rate, such as a motion picture phone or mobile storage device, the domain segmenting portion 103 does not transmit the image signal of the image domain corresponding to the segment at which the layer information 3 or the layer information 2 and 3 is allotted to the encoding portion 104, or can transmit it so as to increase its compression rate. The contents of the image domain having the layer information of 2 and 3 have significance lower than that of the contents of the image domain having the layer information of 1.

The encoding portion 104 hierarchically encodes the present frame that is segmented to each layer and is transmitted from the domain segmenting portion 103, while providing the image feature extracting portion 101 in units of a frame with the activity of the frequency domain in units of a segment, controls the bit rate of a bit stream outputted by the target bit rate or encodes the image signal inputted according to the target layer rate by each layer or encodes the image signal inputted according to the target bit rate and the target layer rate by each layer.

The encoding portion 104 further outputs a bit stream including the allotted layer information and the location information of the corresponding image domain by units of a segment or by units of a layer as shown in FIG. 2B by using the layer pattern transmitted from the image feature extracting portion 101.

To this end, the encoding portion 104 includes first through third layer encoders 301, 302, and 303, a frequency domain activity providing portion 304, and a streamer 305 as shown in FIG. 3.

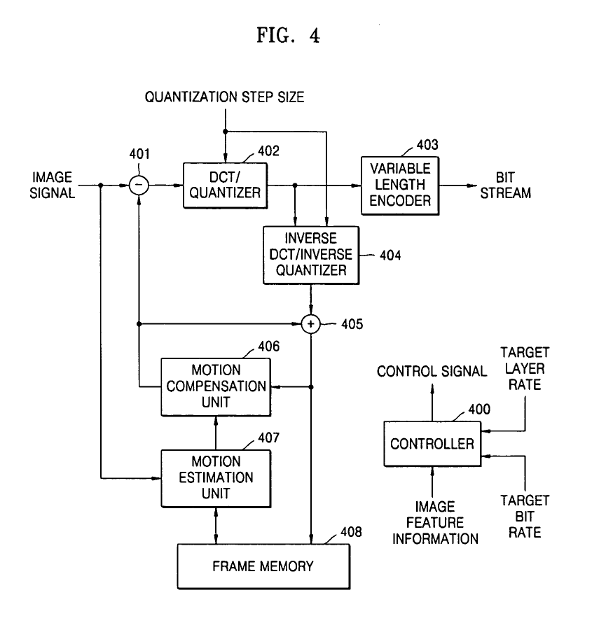

The first through third layer encoders 301, 302, 303, as shown in FIG. 4, each encode the input image signal by constituting a controller 400, a difference detector 401, a DCT and quantizer 402, a variable length encoder 403, an inverse DCT/inverse quantizer 404, a motion compensation unit 406, a motion estimation unit 407, and a memory 408.

The controller 400 receives the target bit rate, target layer rate, and image feature information. The controller 400 outputs encoder control signals and layer rate signals by layers in order to control the layer rate other than a quantization step size based on the received target bit rate and/or the target layer rate and controls the operation of the corresponding encoder. Further, the controller 400 controls the variable length encoder 403 so that the layer information constituting the layer pattern can be transmitted through a header domain as shown in FIG. 2B based on the received image feature information. The controller 400 controls the operation of the corresponding encoder so that the target bit rate information and/or the target layer rate information by layers, the quantization step size information, etc. can be included in the header domain.

However, the first through third layer encoders 301, 302, and 303 can encode an input image signal at target layer rates which are different from each other. That is, the image signal can be encoded by setting the target layer rate of the image domain having the highest significance to be high and setting the target layer rate of the image domain having a relatively low significance to be low. Each target layer rate used in the first through third layer encoders 301, 302, and 303 may be set in advance according to the system target bit rate and the significance of the corresponding layer or may be set in advance according to the significance of the corresponding layer regardless of the target bit rate of system.

Therefore, the target layer rate set in the second layer encoder 302 and the third layer encoder 303 may be smaller than the target layer rate set in the first layer encoder 301.

The quantization step size of the first through third layer encoders 301, 302, and 303 each may be set depending on the target bit rate or the target bit rate and the target layer rate or the target layer rate. For instance, in a case where the transmitted bit rate exceeds the target bit rate, the quantization step size of the second layer encoder 302 and the third layer encoder 303 are set to be large, and in a case where the transmitted bit rate does not exceed the target bit rate, each quantization step size of the second layer encoder 302 and the third layer encoder 303 is set to be small.

Each controller 400 in the first through third layer encoders 301, 302, and 303 can control whether the first through third layer encoders 301, 302, and 303 are encoded according to the corresponding target layer rate.

The bit streams output from the first through third layer encoders 301, 302, and 303 each include additional information necessary for each decompression by units of a layer or units of a segment, and the target layer rate and the target bit rate used in the first through third layer encoders 301, 302, and 303, based on the image feature information on the basis of the layer pattern and the location information of the image domain.

The first through third layer encoders 301, 302, and 303 further provide the frequency domain activity providing portion 304 with a frequency domain activity calculated from the DCT/quantizer 402 by units of a segment.

The first through third layer encoders 301, 302, and 303 may not be operated if the image signal of the corresponding image domain is not inputted.

The frequency domain activity providing portion 304 receives the frequency domain activity in units of a segment from the first through third layer encoders 301, 302, and 303, and transmits it to the image feature information extracting portion 101 by units of a frame.

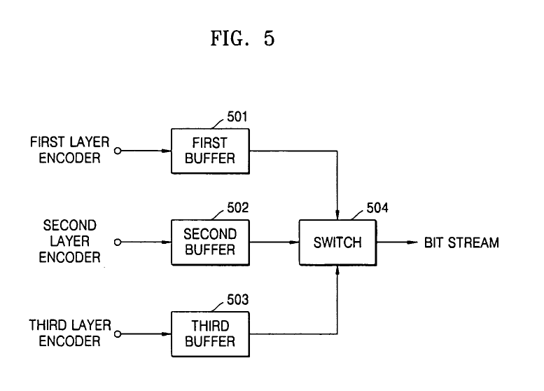

The streamer 305 outputs a bit stream combined with the encoded image signal transmitted from the first through third layer encoders 301, 302, and 303. To this end, the streamer 305 can be constituted as shown in FIG. 5. In other words, the streamer 305 includes first through third buffers 501, 502, and 503, and a switch 504.

The first buffer 501 buffers the bit stream of the encoded image signal transmitted from the first layer encoder 301. The second buffer 502 buffers the bit stream of the encoded image signal transmitted from the second layer encoder 302. The third buffer 503 buffers the bit stream of the encoded image signal transmitted from the third layer encoder 303. If the bit stream of the encoded image signal is not transmitted from the corresponding layer encoder, the corresponding buffer may not be buffered.

The switch 504 selectively transmits the bit stream outputted from the first through third buffers 501, 502, and 503.

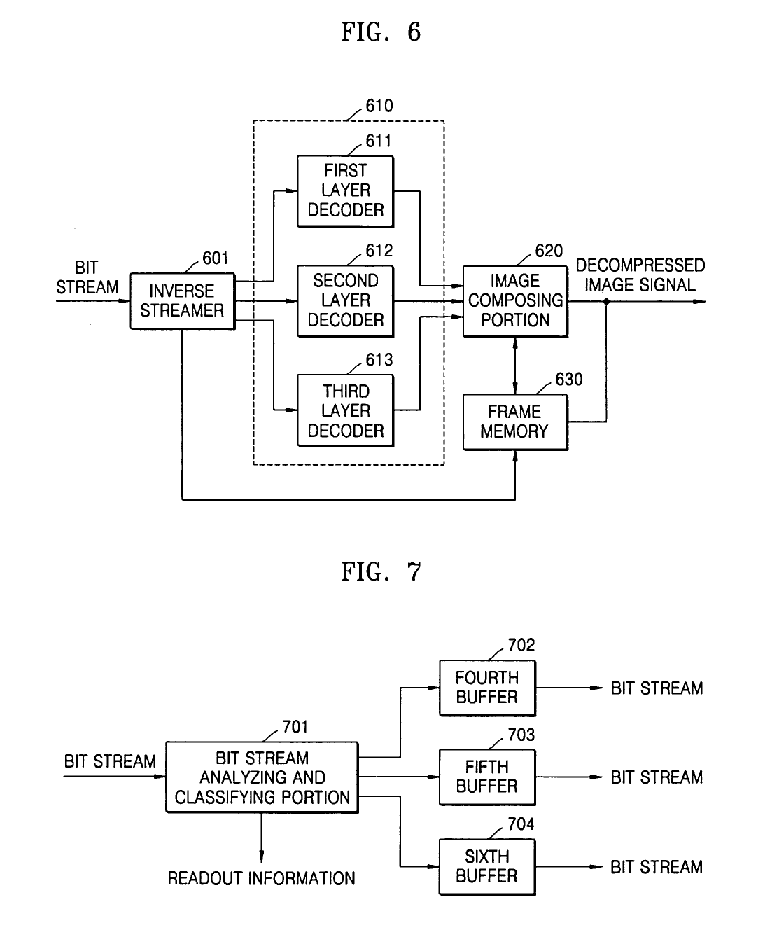

FIG. 6 is a block diagram illustrating an apparatus for decompressing images according to an embodiment of the present invention. Referring to FIG. 6, the apparatus for decompressing an image includes an inverse streamer 601, a decoding portion 610, a domain composing portion 620, and a frame memory 630.

The inverse streamer 601, if a bit stream is received, analyzes the bit stream and classifies the received bit stream into a multiple of layers to be transmitted by layers. The inverse streamer 601 classifies the received bit stream into a multiple of layers by using layer information based on the layer pattern included in the header domain of the received bit stream. The layer information is image feature information extracted from the image feature information extracting portion 101 of FIG. 1.

For example, the bit stream having the layer information of 1 is transmitted to the first layer decoder 611 of the decoding portion 610, the bit stream having the layer information of 2 is transmitted to the second layer decoder 612 of the decoding portion 610, and the bit stream having the layer information of 3 is transmitted to the third layer decoder 613 of the decoding portion 610.

The inverse streamer 601, if there exists a layer that does not receive the bit stream of the image signal, generates readout information of the frame memory 630 based on the location information of the image domain corresponding to the layer. The generated readout information is provided to the frame memory 630.

To this end, the inverse streamer 601 constitutes a bit stream analyzing and classifying portion 701, and fourth through sixth buffers 702, 703, and 704.

The bit stream analyzing and classifying portion 701 analyzes the header domain of the input bit stream by units of a layer or units of a segment and determines the layer information of the bit stream input during the encoding. As a result, the bit stream corresponding to the layer 1 is transmitted to the fourth buffer 702, the bit stream corresponding to the layer 2 to the fifth buffer 703, and the bit stream corresponding to the layer 3 to the sixth buffer 704.

If the received bit stream does not include the bit stream of the encoded image signal of a partial layer, the bit stream analyzing and classifying portion 701 provides the frame memory 630 with the readout information capable of obtaining the previously decompressed image signal of the corresponding layer. The layer that does not include the bit stream of the encoded image signal is an image domain including the contents whose significance is low in the corresponding image or is an image domain having the same contents as those of the previous frame due to no motion of the consecutive image.

The fourth buffer 702 buffers the bit stream transmitted from the bit stream analyzing and classifying portion 701 and transmits it to the first layer decoder 611 of the decoding portion 610. The fifth buffer 703 buffers the bit stream transmitted from the bit stream analyzing and classifying portion 702 and transmits it to the second layer decoder 612 of the decoding portion 610. The sixth buffer 704 buffers the bit stream transmitted from the bit stream analyzing and classifying portion 703 and transmits it to the third layer decoder 613 of the decoding portion 610.

The decoding portion 610 constitutes first through third layer decoders 611, 612, and 613. The first layer decoder 611 decompresses the bit stream transmitted from the fourth buffer 702 to the original image signal by using the quantization step size equal to that used by the first layer encoder 301. The quantization step size is determined depending on a target layer rate or a target bit rate or a target layer rate and a target bit rate used during encoding. The quantization step size is included in the bit stream transmitted to the fourth buffer 702 for transmission. The quantization step size is defined as a decompression rate corresponding to a compression rate during the encoding.

The second layer decoder 612 decompresses the bit stream transmitted from the fifth buffer 703 to the original image signal by using the quantization step size equal to that used by the second layer encoder 302. The third layer decoder 613 decompresses the bit stream transmitted from the sixth buffer 704 to the original image signal by using the quantization step size equal to that used by the third layer encoder 303. As described above, the first through third layer decoders 611, 612, and 613 that the decoding portion 610 includes can decode the inputted bit stream according to the target bit rate and/or the target layer rates which are different from each other.

The image composing portion 620 composes decompressed image signals transmitted from the first through third layer decoders 611, 612, and 613 and outputs the decompressed image signal. However, if the decompressed image signal is transmitted from the first layer decoder 611 among the first through third layer decoders 611, 612, and 613 and the decompressed image signals of other image domains are transmitted from the frame memory 630, the image composing portion 620 composes these image signals and outputs the decompressed image signal.

The frame memory 630 stores the decompressed image signal of the previous frame. Accordingly, if the image signal decompressed from the image composing portion 620 is outputted, the image signal of the previous frame stored in the frame memory 630 is updated by the output decompressed image signal.

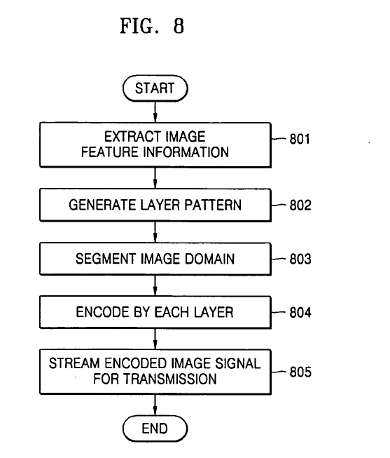

FIG. 8 is a flow chart describing the operation of a method for compressing image according to an embodiment of the present invention. The image feature information of the input image signal is extracted in operation 801. To be specific, like the image feature information extracting portion 101 of FIG. 1, the image feature information capable of dividing the input image domain by contents is extracted. For example, the image feature information capable of dividing the contents corresponding to the object domain and contents corresponding to the background domain is extracted. The image feature information can be extracted by units of a predetermined segment as shown in FIG. 2A. The image feature information can be further extracted based on the activity or complexity of the image signal.

Next, the layer pattern corresponding to the image feature information extracted based on the defined encoding layer is generated in operation 802 as shown in FIG. 2B. The domain of the inputted image signal is segmented in operation 803 based on the layer information constituting the generated layer pattern.

The segmented image signals are encoded in operation 804 by each layer as described referring to FIG. 3. In the segmented image signals, only the image signal of the image domain of the layer having the highest significance can be encoded. In a case where the target bit rate set during recording or transmission is low or there is almost no motion of the consecutive image signal, only the image signal of the image domain of the layer having the highest significance can be encoded. The image domain corresponding to the layer having the highest significance may be an image domain including the contents having the highest significance in the corresponding image. Or a domain near the layer having the highest significance or a middle domain of the image having a low significance may be included in the layer having the highest significance.

When the image signals are encoded by layers, they may be encoded by the target bit rate and/or the target layer rates which differ from each other depending on the significance of the layer, transmission/recording environments, and purpose of application. The target layer rate and the target bit rate may be set in advance. For example, the image signal may be encoded by setting the target layer rate of the layer having the highest significance to be higher than the target layer rate of the layer having a relatively low significance. The target bit rate can be variably adjusted depending on the transmission/recording environments and purpose of application. During encoding of the image signal by layers, the used target bit rate, target layer rate, quantization step size, layer information, and location information of the image domain may be included in the header domain.

The bit stream of the image signal encoded by layers is streamed for transmission in operation 805.

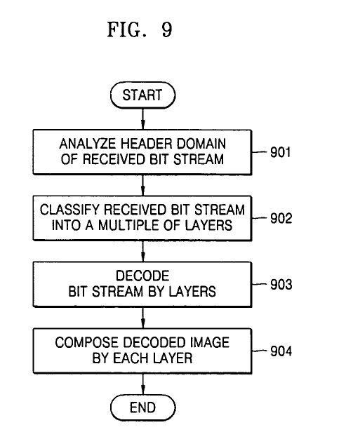

FIG. 9 is a flow chart describing the operation of a method for decompressing images according to an embodiment of the present invention. If the bit stream is received, the header domain of the received bit stream is analyzed in operation 901. The received bit stream is classified in operation 902 into a multiple of layers based on the analyzed header domain information. The header domain information may include the layer information on the basis of the layer pattern, location information of the corresponding image domain, and target layer rate and target bit rate used during the encoding by layers.

Therefore, the received bit stream based on the layer information may be classified. The layer information constitutes the layer pattern of FIG. 2B.

The classified layered bit stream is decoded in operation 903 by using the quantization step size used during encoding as in the encoding portion 610 of FIG. 6.

The decoded layered image signal is composed to obtain in operation 904 the decompressed image signal.

FIG. 9 is a case in which all the layered bit streams are received. However, the bit stream of the layer having a low significance may not be received as described in the image decompressing device of FIG. 6. If there exists a layer in which the bit stream is not received, the image domain corresponding to the layer obtains the decompressed image signal from the previously decompressed image signal based on the location information that is included in the corresponding header domain, composes the decompressed image signal and a decompressed image signal of another layer, and generates a decompressed image signal of one frame. Whenever the decompressed image signal of one frame is generated, the previously decompressed image signal is updated.

A method of hierarchically compressing and decompressing an image signal and an apparatus using the same according to an embodiment of the present invention have been particularly shown and described with reference to exemplary embodiments thereof A case of segmenting a single image into three domains is exemplified for convenience of description. However, the present invention can be applied when encoding and decoding a single image having n layers.

As such, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the present invention is defined not by the detailed description of the invention but by the appended claims, and all differences within the scope of the present invention will be construed as being included in the present invention.

As described above, the present invention segments an image domain in a multiple of layers according to the significance of contents, compresses and decompresses an image signal by each layer using a target bit rate which is varied depending on the transmission/recording environments and purpose of application and/or a target layer rate which differs from each other so as to transmit or record the image signal at a low bit rate while maintaining the definition of important information (or contents having high significance) in the image to be transmitted. Therefore, there can be provided an apparatus for compressing and decompressing an image suitable for an environment where transmission is poor or a storage capacity is insufficient, such as a motion picture phone or a mobile storage device.

What is claimed is:

1. A method of decompressing an image, the method comprises the operations of:
classifying a received bit stream into multiple layers;
decoding the bit stream classified by each layer, and obtaining a decompressed image signal of each layer; and
composing the decompressed image signal of each layer.

2. The method according to claim 1, wherein a bit stream classified by each layer is decoded at a decompression rate corresponding to a compression rate based on target layer rates which are different from each other by each layer, each layer being classified based on layer information included in the received bit stream.

3. The method according to claim 2, wherein the layer information comprises a layer pattern capable of dividing an image domain by contents.

4. The method according to claim 3, wherein the target layer rates which are different from each other are determined according to significance of contents of the image.

5. The method according to claim 2, wherein the bit stream classified by each layer is decoded at the decompression rate corresponding to the compression rate based on a target bit rate used at a decoding and the target layer rates which are different from each other by each layer.

6. The method according to claim 1, wherein the bit stream classified by each layer is decoded at a decompression rate corresponding to a compression rate based on the target bit rate used in an encoding.

7. A method of decompressing an image, the method comprising the operations of:
classifying a received bit stream into multiple layers based on image layer information;
obtaining a decompressed image signal by decoding a bit stream of a layer having the highest significance in the multiple layers;
obtaining an image signal corresponding to other layers than the layer having the highest significance in the multiple layers from a previously decompressed image signal based on additional information included in the received bit stream; and
composing the decompressed image signal and the image signal obtained from a previously decompressed image signal, and outputting the composed image signal to the decompressed image signal.

8. The method according to claim 7, wherein the layer having the highest significance includes at least one domain between a boundary domain of the image having the highest significance in the image and a middle domain of the image.

9. An apparatus for decompressing an image, the apparatus comprising:
an inverse streamer configured to, if a bit stream is received, analyze the bit stream to be classified into multiple layers and transmitting the bit stream by layers;
a decoding portion configured to decode the bit stream by each layer transmitted from the inverse streamer and output a decompressed image signal of each layer; and
an image composing portion configured to compose the decompressed image signal of each layer.

10. The apparatus according to claim 9, wherein the inverse streamer classifies the received bit stream into the multiple layers based on layer information included in the received bit stream.

11. The apparatus according to claim 10, wherein the image layer information comprises a pattern capable of dividing an image domain by contents.

12. The apparatus according to claim 9, wherein the decoding portion decodes the bit stream by each layer using a decompression rate corresponding to a compression rate based on target layer rates which are different from each other by each layer.

13. The apparatus according to claim 9, wherein the decoding portion decodes the bit stream by each layer by using a decompression rate corresponding to a compression rate based on a target bit rate used during decoding and target layer rates which are different from each other by each layer.

14. The apparatus according to claim 9, wherein the decoding portion decodes the bit stream by each layer by using a decompression rate corresponding to a compression rate based on the target bit rate used during encoding.

15. An apparatus for decompressing an image, the apparatus comprising:
an inverse streamer configured to classify a received bit stream into multiple layers and output readout information based on a bit stream of a layer having the highest significance and additional information of other layers than the layer having the highest significance in the multiple layers;
a decoding portion configured to decode the bit stream transmitted from the inverse streamer and output the decompressed image signal;
an image composing portion configured to compose the decompressed image signal of each layer;
a frame memory configured to provide a previously decompressed image signal of an image domain corresponding to the other layers based on the readout information; and
an image composing portion configured to compose the decompressed image signal outputted from the decoding portion and the previously decompressed image signal provided from the frame memory and output the composed image signal.

16. The apparatus according to claim 15, wherein the layer having the highest significance includes at least one domain between a boundary domain of the image having the highest significance in the image and a middle domain of the image.

17. A method of compressing an image, the method comprising the operations of:
extracting image feature information;
generating a layer pattern of the image based on the extracted image feature information and a number of encoding layers of the image;
segmenting an image domain based on the layer pattern;
encoding an image signal by the segmented image domain; and
composing the encoded image signal by image domains and outputting the composed image signal.

18. The method according to claim 17, wherein the encoding operation encodes an image signal of the segmented image domain of a compression rate based on target layer rates which are different from each other by the segmented image domain according to the significance of contents of the segmented image domain.

19. The method according to claim 17, wherein the encoding operation encodes an image signal of the segmented image domain at a compression rate determined based on a target bit rate and target layer rates which are different from each other by the segmented image domain.

20. The method according to claim 17, wherein the encoding operation encodes an image signal of the segmented image domain at a compression rate determined based on a target bit rate.

21. A method of compressing an image, the method comprising the operations of:
extracting image feature information;
generating a layer pattern of the image based on the extracted image feature information and a number of encoding layers of the image;
segmenting an image domain based on the layer pattern; and
encoding an image signal of the image domain having the highest significance of the image in the segmented image domain.

22. The method according to claim 21, the method further comprising the operation of composing additional information necessary for decompressing image domains other than the image domain having the highest significance in the image among the segmented image domain and the encoded image signal.

23. An apparatus for compressing an image, the apparatus comprising:
an image feature extracting portion configured to extract feature information of an input image, and generate a layer pattern corresponding to the image based on the extracted image feature information and a number of encoding layers of the image;
a domain segmenting portion configured to segment an image domain based on the layer pattern; and
an encoding portion of encoding an image signal of the image domain segmented by the domain segmenting portion.

24. An apparatus for compressing an image, the apparatus comprising:
an image feature information extracting portion configured to extract feature information of an input image, and generate a layer pattern corresponding to the image based on the extracted image feature information and a number of encoding layers of the image;
a domain segmenting portion configured to segment an image domain based on the layer pattern; and
an encoding portion configured to encode an image signal of an image domain having the highest significance in the image domain segmented by the domain segmenting portion, and outputting the encoded image signal and additional information necessary for decompressing image signals of other image domains which are not encoded in the segmented image domain as a bit stream.
